(19) United States
(12) Patent Application Publication
(10) Pub. No.: US 2014/0141725 A1
(43) Pub. Date: May 22, 2014

(54) WIRELESS PRESENTATION SYSTEM ALLOWING AUTOMATIC ASSOCIATION AND CONNECTION

(71) Applicants: Ronald D. Jesme, Plymouth, MN (US); Craig R. Schardt, Woodbury, MN (US); Patrick M. Campbell, St. Paul, MN (US); Patrick A. Thomas, Lake Elmo, MN (US); Ernesto M. Rodriguez, JR., Austin, TX (US); George D. Kokkosoulis, Cedar Park, TX (US); Daniel A. Syrstad, Burnsville, MN (US); Douglas S. Parker, Afton, MN (US)

(72) Inventors: Ronald D. Jesme, Plymouth, MN (US); Craig R. Schardt, Woodbury, MN (US); Patrick M. Campbell, St. Paul, MN (US); Patrick A. Thomas, Lake Elmo, MN (US); Ernesto M. Rodriguez, JR., Austin, TX (US); George D. Kokkosoulis, Cedar Park, TX (US); Daniel A. Syrstad, Burnsville, MN (US); Douglas S. Parker, Afton, MN (US)

(21) Appl. No.: 14/130,645

(22) PCT Filed: Jul. 27, 2012
(86) PCT No.: PCT/US12/48459

§ 371 Date: Jan. 2, 2014

Related U.S. Application Data
(60) Provisional application No. 61/513,245, filed on Jul. 29, 2011.

(51) Int. Cl. H04W 76/02

(52) U.S. Cl. CPC H04W 76/02
USPC 455/66.1

(57) ABSTRACT

A wireless presentation system includes communication means for line-of-sight communication links such that an association between a content holder and a desired presentation device can be automatically established using line-of-sight communication links.

### BACKGROUND

In environments where a presentation device is available for use by multiple presentation participants, the connection to the presentation device is typically via a wire cable. A wired connection provides an association between the presentation device and a content holder of one of the presentation participants while also providing a communication path for presentation content.

### SUMMARY

In one embodiment, a wireless presentation system includes a first presentation device having a wireless identification, a line-of-sight communication transmitter, a line-of-sight communication receiver, and a first content holder coupled to the line-of-sight communication receiver. The line-of-sight communication transmitter is configured to transmit the wireless identification of the first presentation device via a line-of-sight communication transmission. The line-of-sight communication receiver is configured to receive the wireless identification of the first presentation device. The first content holder is configured to obtain the wireless identification of the first presentation device from the line-of-sight communication receiver, the first content holder further configured to establish a first wireless connection with the first presentation device using the wireless identification of the first presentation device and transmit content to the first presentation device via the first wireless connection.

In another embodiment, a method includes the steps of transmitting, by a line-of-sight communication transmitter, a wireless identification of a presentation device via a line-of-sight transmission; receiving, by a line-of-sight communication receiver coupled to a content holder, the wireless identification of the presentation device; establishing a wireless connection between the presentation device and the content holder using the wireless identification of the presentation device; and sending presentation content via the wireless connection, via the content holder to the presentation device.

### BRIEF DESCRIPTION OF THE DRAWINGS

The accompanying drawings are incorporated in and constitute a part of this specification and, together with the description, explain the advantages and principles of the invention. In the drawings,

FIG. 1 illustrates an exemplary block diagram of a wireless presentation system allowing automatic association and connection;

FIGS. 2A and 2B are exemplary system diagrams for a wireless presentation system allowing automatic association and connection;

FIG. 3A illustrates a scenario of two wireless presentation systems;

FIG. 3B is an illustration of an exemplary signal propagation diagram of two wireless presentation systems;

FIG. 4A is an exemplary logical flowchart of a line-of-sight communication transmitter;

FIG. 4B is an exemplary logical flowchart of a content holder;

FIG. 4C is an exemplary logical flowchart of a presentation device;

FIG. 5 is an exemplary sequential interaction flowchart of components in a wireless presentation system allowing automatic association and connection;

FIGS. 6A and 6B illustrate exemplary wireless presentation systems having a plurality of content holders;

FIG. 7 illustrates an exemplary wireless presentation system having two presentation devices; and

FIG. 8 illustrates another exemplary wireless presentation system having two presentation devices.

### DETAILED DESCRIPTION

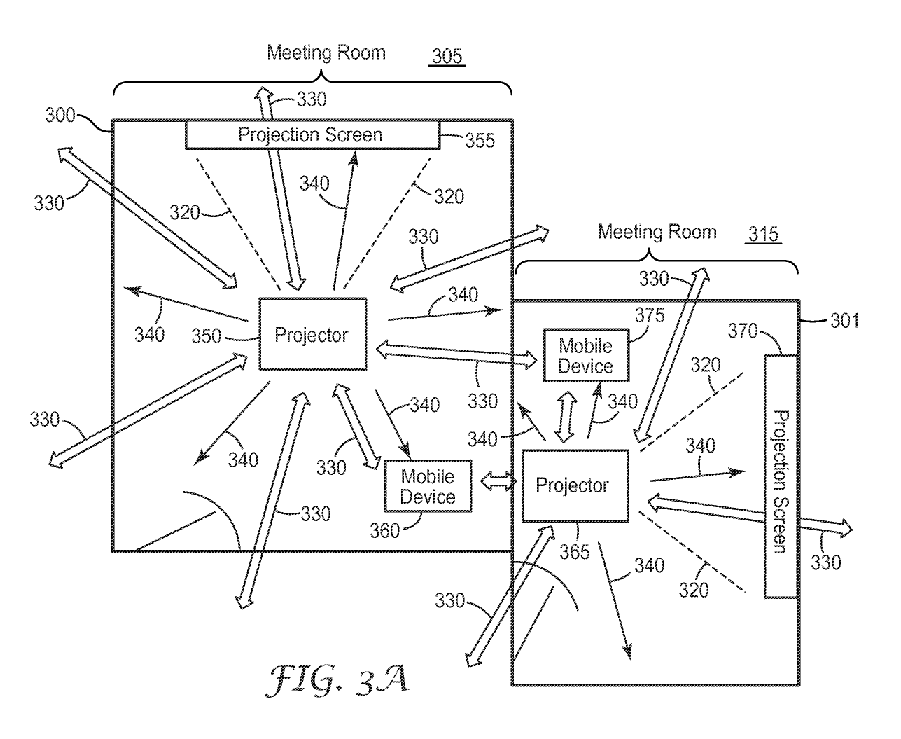

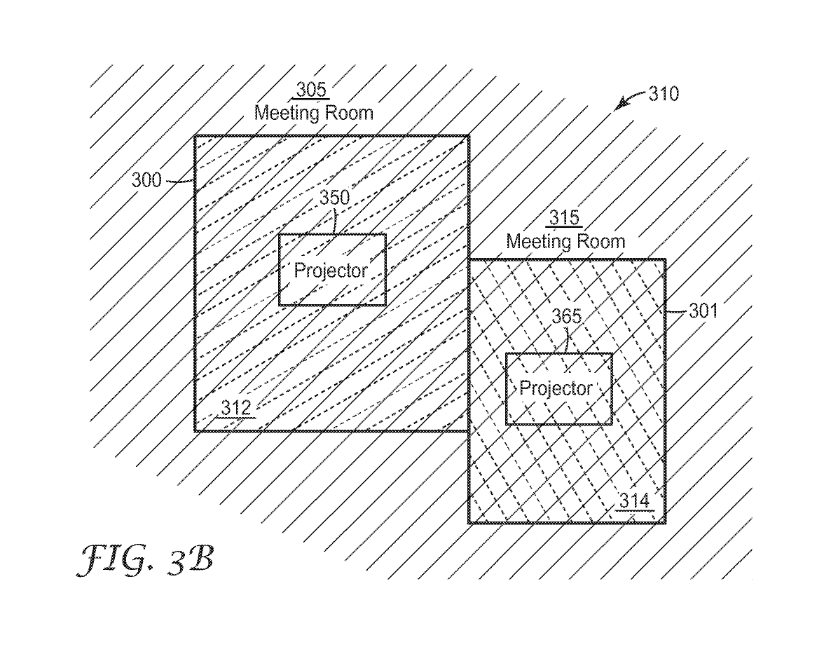

A wired connection can provide a reliable communication path between a presentation device and a content holder. Switching a presentation device between multiple content holders via a wired connection, however, requires physically disconnecting one content holder from the presentation device and connecting another content holder to the presentation device. In addition, in a wired system, typically a content holder and a presentation device must be located in the same room. Connecting a presentation device to a content holder via a wireless connection allows switching content holders and/or presentation devices without the necessary efforts of plugging in and unplugging. Since wireless communications are often capable of penetrating construction materials, like walls, the association between a content holder and a proper presentation device via a wireless link could be erroneous. If there is more than one presentation device within the range of wireless communication of a content holder, it may not be clear to the content holder which presentation device is of interest. Additionally, for adjacent conference rooms, a content holder in one room may be closer to a presentation device in another conference room, as illustrated in FIG. 3A. In this situation, if a content holder simply broadcasts its presentation content via a wireless communication interface, the presentation content may reach a presentation device in another room. The present disclosure aims to solve such issues.

Specifically, the present disclosure is directed to systems and methods for providing a line-of-sight communication interface to automatically associate a content holder with a proper presentation device. As used herein, a line-of-sight communication refers to a wireless communication between a transmitter and a receiver that is predominantly constrained to a limited space. In some cases, the transmitter and receiver antennas can be in visual contact with one another (i.e., there is an unobstructed, straight-line path between the transmitter antenna and the receiver antenna). Despite the title, line-of-sight communications are not limited to communications between a transmitter antenna and a receiver antenna having a visually unobstructed straight-line path. In some cases, line-of-sight communication signals (i.e., electromagnetic or acoustic wave) can be greatly attenuated and/or reflected by intervening construction materials such that the communication is generally limited to a room where the signal is originated. In such cases, because the communication signals can be reflected one or more times within a room boundary, there is no need to have an unobstructed straight-line path between a transmitter aperture and receiver aperture. In some other cases, the line-of-sight communication signals may have a rapid rate of attenuation versus distance traveled. Line-of-sight communication interfaces may be, for example, communications via visible, infrared or ultraviolet light, or air transported acoustic waves including sound and ultrasound, near field communication (NFC), electrical waves, and the like. Line-of-sight communication established by longer-wavelength light (i.e., infrared, etc.) may have an advantage because it is does not penetrate most construction materials such as wall, door, ceiling and floor, and it is constrained to a room. It is at least partially reflected by most building materials and room contents so it can be propagated to otherwise obstructed portions of a room. It can be controlled to be directional so it can be used to selecting a specific display among multiple displays in a room. Further, it is not visible so it is unobtrusive to presentation recipients. Line-of-sight communication established by a sound emission may have several advantages: it is constrained by building materials; it does not require a straight-line path; it can be at least partially reflected by building materials and it can penetrate clothing so it can propagate to otherwise obstructed portions of a room; and if ultrasonic acoustic emission is used, it is not audible so it is unobtrusive to the presentation recipients.

Rooms typically have generally opaque walls, ceilings and floors that generally prohibit escape or entrance of various forms of light. As another example, rooms, especially meeting rooms and classrooms, typically have walls, ceiling and floors that greatly attenuate sound that might otherwise enter or leave the room. It is desirable to prevent an event held in one room from disturbing an event held in a nearby room, and to preserve privacy. Communications based on magnetic fields (such as near field communication (NFC)) or electric fields alone (as opposed to a balance of electromagnetic fields such as in propagating electromagnetic waves) may also be used as line-of-sight communication methods to limit the range of communication because of the rapid rate of attenuation versus distance traveled. It is noted that some room structures do not provide significant attenuation to communication modes based on magnetic fields or electric fields alone. A line-of-sight communication link may be established by, for example, sonic transmitter and receiver, light transmitter and receiver, near field communication devices, and/or the like. In one specific example, a line-of-sight communication link may be established by an ultrasonic or infrared transmitter and receiver.

A presentation device can be any device having display or projecting capability. For example, a presentation device can be a projector, a display, a mobile computer screen, a mobile phone screen, or the like. In some configurations, a presentation device may include a processor and a memory for storing and/or decoding presentation content. A content holder can be any device storing or having access to presentation content. In some embodiments, a content holder may be associated with a presentation device in a same room via a line-of-sight communication link. A room can be any partitioned space. A room is not necessarily a total enclosed space partitioned by walls and doors. A room, for example, may be a cubicle area. In an exemplary embodiment, a line-of-sight communication transmitter is configured to broadcast a wireless identification of a presentation device in a same room. The line-of-sight communication transmitter may be associated with the presentation device to the extent that the wireless identification of the presentation device is known to the transmitter. In some implementations, the line-of-sight communication transmitter may be coupled to the presentation device via a wired or wireless connection. In some other implementations, the line-of-sight communication transmitter may be a separate device that is not coupled to the presentation device via any means. In yet other implementations, the line-of-sight communication transmitter may be an integrated part of the presentation device.

A content holder may receive the wireless identification of the presentation device via a line-of-sight communication receiver that is coupled to the content holder. Next, the content holder may use the wireless identification to establish a wireless connection with the presentation device. In some configurations, the line-of-sight communication receiver may be an integrated part of the content holder. In some other configurations, the line-of-sight communication receiver may be a standalone device connected to the content holder.

After a wireless connection is established between the content holder and the presentation device, the content holder is configured to transmit presentation content to the presentation device via the wireless connection. The wireless connection may be any short-range or long range wireless interface providing sufficient bandwidth for content transmission. The short-range communication interfaces may be, for example, interfaces conforming to a known communications standard, such as Bluetooth standard, IEEE 802 standards (e.g., IEEE 802.11), a ZigBee or similar specification, such as those based on the IEEE 802.15.4 standard, or other public or proprietary wireless protocol. The long-range communication interfaces may be, for example, cellular network interfaces, satellite communication interfaces, or the like.

By supplementing a wireless communication interface with a line-of-sight communication interface, a content holder may be automatically associated with a proper presentation device. Using the line-of-sight communication interface, an encryption key or other security measures may be transmitted within a room. Therefore, the wireless communication of the presentation content or other information may utilize such security measures to provide reliable and secure communication between the presentation device and the content holder.

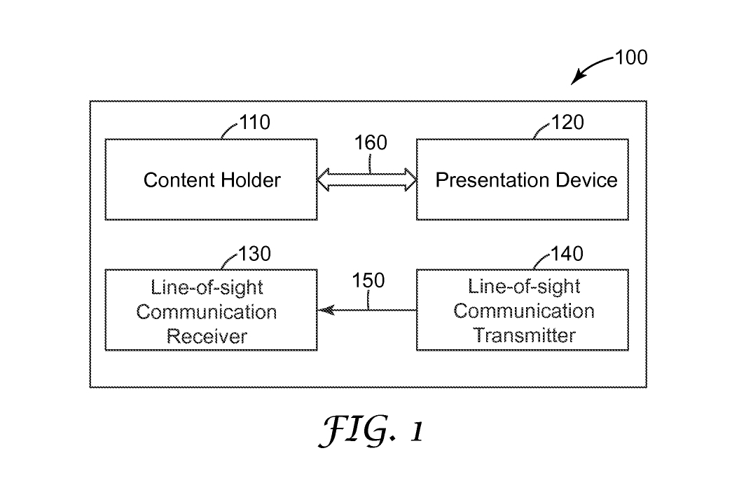

FIG. 1 provides an exemplary block diagram for a wireless presentation system 100 allowing automatic association and connection. In one embodiment, the wireless presentation system 100 includes a content holder 110, a presentation device 120, a line-of-sight communication receiver 130, and a line-of-sight communication transmitter 140. The line-of-sight communication receiver 130 can be coupled to the content holder 110. The line-of-sight communication transmitter 140 can be associated with the presentation device 120. The line-of-sight communication transmitter 140 is configured to transmit signal via a line-of-sight communication interface. The line-of-sight communication receiver 130 is configured to receive signal via a line-of-sight communication interface. A line-of-sight communication connection 150 can be established between the transmitter 140 and the receiver 130. In some embodiments, a wireless identification of the presentation device 120 can be transmitted via the transmitter 140 and received by the receiver 130. The content holder 110 may use the wireless identification of the presentation device 120 to establish a wireless connection 160 with the presentation device 120. The wireless identification may be any data or information that can identify the presentation device 120. For example, the wireless identification may be an ip (i.e., internet protocol) address, a room number, a device identification, a cellular phone number, a satellite network identification, or the like. The wireless identification may include security related data for wireless connection, for example, a pass code. The wireless identification may be a combination of multiple pieces of data, for example, a combination of a device identification and a pass code to allow secured connection.

In an exemplary embodiment, the line-of-sight communication transmitter 140 may also transmit one or more encryption keys via the line-of-sight communication interface. The encryption keys may be used to encrypt and decrypt presentation content transmitted via the wireless connection 160. In some embodiments, data to facilitate wireless connection between the content holder 110 and the presentation device 120 may be communicated via the line-of-sight communication connection 150. Further, in some embodiments, other data related to the configuration of the presentation device 120 may be communicated via the line-of-sight communication connection 150. In some implementations, the content holder 110 may include a wireless transceiver. In some other implementations, a wireless transceiver may be a separate device that is coupled to the content holder 110. Similarly, a wireless transceiver may be an integrated part of the presentation device 120, or may be a separate device that is coupled to the presentation device 120. The content holder 110 may use the data received via the line-of-sight communication interface to establish a wireless connection with the presentation device 120. In some embodiments, the line-of-sight communication interface between the line-of-sight communication receiver 130 and the line-of-sight communication transmitter 140 may be bi-directional. In such configuration, both the receiver 130 and the transmitter 140 may transmit and receive data via a line-of-sight communication interface. In some cases, the content holder 110 may control the set-up and configuration of the presentation device 120 via a wireless connection or a line-of-sight communication link.

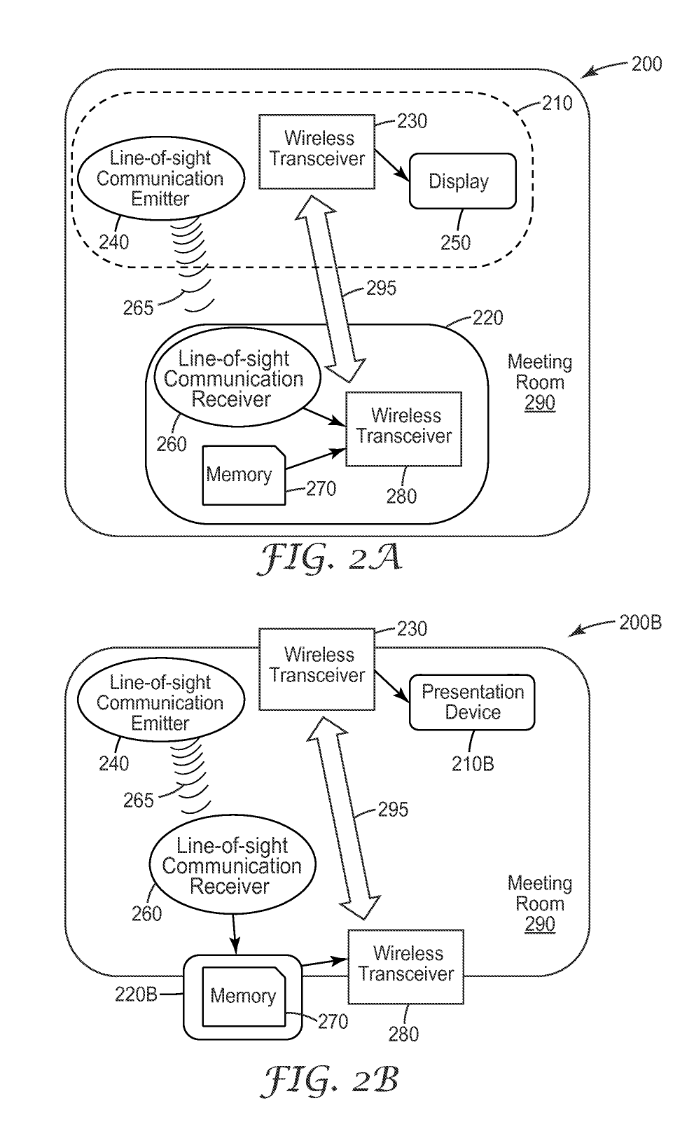

FIG. 2A is an exemplary system diagram for a wireless presentation system 200 allowing automatic association and connection. In one embodiment, the wireless presentation system 200 may include a presentation device 210 and a content holder 220. The presentation device 210 and the content holder 220 are within a room 290. In some embodiments, the presentation device 210 may include a display 250, a wireless transceiver 230, and a line-of-sight communication emitter 240 that is also referred to as a line-of-sight communication transmitter herein. In some embodiments, as illustrated in FIG. 2A, the content holder 220 may include a memory 270, a line-of-sight communication receiver 260, and a wireless transceiver 280. In some implementations, the content holder 220 may include a processor. The memory 270 provides content storage or a temporary memory space for content passing. The memory 270 can be any data storage medium. The memory 270 can be a non-transitory data storage medium, a transitory data storage medium, or a combination of both. For example, the memory 270 may be a flash memory, a hard drive, a compact disk, or the like. A line-of-sight communication connection 265 may be established between the line-of-sight communication emitter 240 and the line-of-sight communication receiver 260. A wireless identification or other data that may aid in setting up wireless connection to the presentation device 210 are propagated via the line-of-sight communication connection 265.

A wireless connection 295 between the wireless transceiver 230 coupled to the presentation device 210 and the wireless transceiver 280 coupled to the content holder 220 may be established using the wireless identification or other data. In some embodiments, the memory 270 can be configured to provide presentation content to the wireless transceiver 280. The wireless transceiver 280 can be configured to transmit the presentation content via the wireless connection 295. The wireless transceiver 230 may receive the presentation content via the wireless connection 295 and the presentation content may then be presented on the display 250. The presentation content may be of any form, for example, visual content, audio content, a combination of visual and audio content, or the like. The presentation content format may be raw digitized image or audio data, compressed (either lossy or lossless) image or audio data, or data file formats such as portable document format, and compressed video formats, or the like which are decoded and rendered by the display device.

The wireless transceiver 230 may be a standalone device coupled to the presentation device 210B, as illustrated in FIG. 2B. Referring to FIG. 2B, an exemplary wireless presentation system 200B may include a presentation device 210B, a content holder 220B, a line-of-sight communication emitter 240, a line-of-sight communication receiver 260, a wireless transceiver 230 coupled to the presentation device 210B, and a wireless transceiver 280 coupled to the content holder 220B. In some implementations, the wireless transceiver 230 may be in a different room from the room where the presentation device 210B is located. In some configurations, the wireless transceiver 230 may be coupled to more than one presentation devices. The wireless transceiver 230 may be coupled to the presentation device 210B by any type of data connections, for example, a dedicated data link, a local area network (LAN) link, or the like. In some implementations, the line-of-sight communication emitter 240 may also be a standalone device. The line-of-sight communication emitter 240 may be associated with the presentation device 210B where the wireless identification or other data related to the presentation device 210B is transmitted by the line-of-sight communication emitter 240. In some implementations, the line-of-sight communication emitter 240 may not be coupled to the presentation device 210B physically.

In some embodiments, the wireless transceiver 280 may be a standalone device coupled to the content holder 220B, as illustrated in FIG. 2B. In some configurations, the wireless transceiver 280 may be coupled to more than one content holders. The wireless transceiver 280 may be coupled to the content holder 220B by any type of data connections, for example, a dedicated data link, a local area network (LAN) link, or the like. In some implementations, the line-of-sight communication receiver 260 may also be a standalone device coupled to the content holder 220B. The line-of-sight communication receiver 260 may be coupled to the content holder 220B by any type of data connections, for example, a dedicated data link, a local area network (LAN) link, or the like. In an exemplary embodiment, the line-of-sight communication receiver 260 may receive the wireless identification or other data related to the presentation device 210B via the line-of-sight communication interface 265 and provide the received data to the content holder 220B. The content holder 220B may use the received data to instruct the wireless transceiver 280 to establish a wireless connection 295 with the wireless transceiver 230. In some implementations, for example, when the wireless transceiver 230 is coupled to a plurality of presentation devices, the wireless identification may include a combination of the wireless transceiver 230's network address and the identification of the presentation device 210B. In some cases, the wireless connection 295 may be a secured connection. Security related data, for example, the type of security and encryption keys, may also be transmitted via the line-of-sight communication link 265. In some implementations, the content holder 220B may retrieve presentation content from a data storage medium located locally or remotely.

In some implementations, the content holder 220B and/or the wireless transceiver 280 may be located in a different room from the meeting room 290 where the presentation device 210B is located. In some configurations, the line-of-sight communication emitter 240, the presentation device 210B, and the line-of-sight communication receiver 260 are located in the meeting room 290. The wireless transceiver 230, the content holder 220B together with the memory 270, and the wireless transceiver 280 can locate in a different room. The content holder 220B can obtain the wireless identification of the presentation device 210B via the coupled line-of-sight communication receiver 260. After an association with the presentation device 210B is established, the content holder 220B, although it is located in a different room, may transmit presentation content via the coupled wireless transceiver 280 to the presentation device 210B.

FIG. 3A illustrates a scenario with two adjacent meeting rooms, each having a wireless presentation system allowing automatic association and connection. A wireless presentation system 300 resides in the meeting room 305 and a wireless presentation system 301 resides in the meeting room 315. The presentation devices shown in FIG. 3A, as an exemplary embodiment, are projectors with projection screens. In each meeting room, there is a projector and a projection screen, with dotted lines 320 showing the visible image being projected from a projector onto a corresponding projection screen. The content holder may be a mobile device, as illustrated in FIG. 3A. The thin one-way arrows 340 depict line-of-sight communication signal propagating from the line-of-sight communication transmitters in various direction around the room in which it is mounted. A majority of the line-of-sight communication signal, which could be emitted by the projector or by a separate device inside the room, does not propagate beyond the room in which it originates. The wide two-way arrows 330 depict wireless communications, which do propagate through the walls of the room enabling communications with devices beyond the walls of the room in which the devices reside. As an example, the wireless presentation system 300 in the meeting room 305 includes a projector 350, a projection screen 355, and a mobile device 360. The wireless presentation system 301 in meeting room 315 includes a projector 365, a projection screen 370, and a mobile device 375. Note that, in this exemplary embodiment, the mobile device 360 in the Meeting Room 305 is closer to the projector 365 in a different Meeting Room 315 than it is to the projector 350 in the same meeting room 305. The mobile device 360 potentially provides a stronger wireless connection to the projector 365 in a different meeting room 315 than the projector 350 in the same meeting room 305.

In an exemplary embodiment, a line-of-sight communication transmitter associated with a presentation device periodically transmits an infrared (IR) signal containing a unique identification (ID) number and an encryption key. When a content holder (i.e., mobile device, laptop, phone, etc.) enters the room where the presentation device resides, the IR signal is received by the content holder via a coupled IR receiver. The content holder may initiate a wireless transmission to the projector, with data encrypted using the encryption key supplied via the IR transmission. This wireless transmission could also contain the unique ID number provided by the line-of-sight communication transmitters via the IR communication links. This process can automatically create a communication link that can subsequently be used to securely transfer content to the proper projector via the wireless link. If the wireless communication to the presentation device is not encrypted with the proper encryption key, or does not include the proper unique ID number, the presentation device can ignore this communication. This prevents a content holder from inadvertently or intentionally connecting to a presentation device in another room.

In some embodiments, multiple content holders within a single room could be connected to the presentation device in that room. In some cases, the presentation content supplied by a first content holder to a presentation device could be shared via the presentation device with a second content holder connected to the same presentation device. In an exemplary embodiment, a first content holder is configured to establish a first wireless connection with the presentation device. A second content holder is also configured to establish a second wireless connection with the first presentation device. In some cases, the presentation device is configured to transmit content transmitted from the first content holder to the second content holder. In some configurations, the second content holder may capture content being projected by the first content device via the presentation device.

In some implementations, the wireless transceiver coupled to the presentation device could function as a wireless hub to which other devices connect in a peer-to-peer fashion. In some other implementations, the wireless transceiver coupled to the presentation device could function as a wireless client that is connected to a hub or router. In such implementations, the line-of-sight communication signal may provide instructions and a key to allow the content holder to connect to the hub or router and to address the correct projector. If there are more than one content holders in the room, each content holder may establish a unique and secured communication path to the presentation device. This allows multiple presentation devices in difference rooms to connect to a single wireless router within a building infrastructure housing all of the rooms. Such implementations also allow the content holder and the presentation device to also have access to the internet.

FIG. 3B is an illustration of an exemplary signal propagation diagram of two wireless presentation systems. For example, wireless communications, illustrated as lines 310, can generally propagate through office structures, with slight impedance by walls, ceilings, floors, etc. Line-of-sight communications, illustrated as lines 312 and 314 are generally restricted to a room, for example, by the room's walls, ceiling, floor, etc. The construction material may reflect or absorb line-of-sight communication signals. In an exemplary embodiment as illustrated in FIG. 3B, the line-of-sight communication coverage in the meeting room 305, as indicated by sloping up lines 312, is shown to be confined to the meeting room 305. The line-of-sight communication coverage of the meeting room 315, as indicated by sloping down lines 314, is shown to be confined to the meeting room 315, while the wireless coverage permeates all the spaces shown.

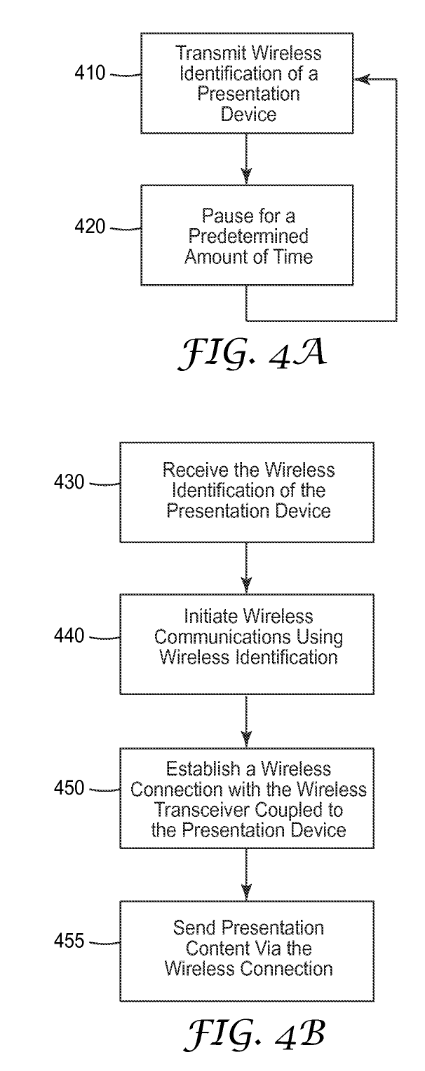

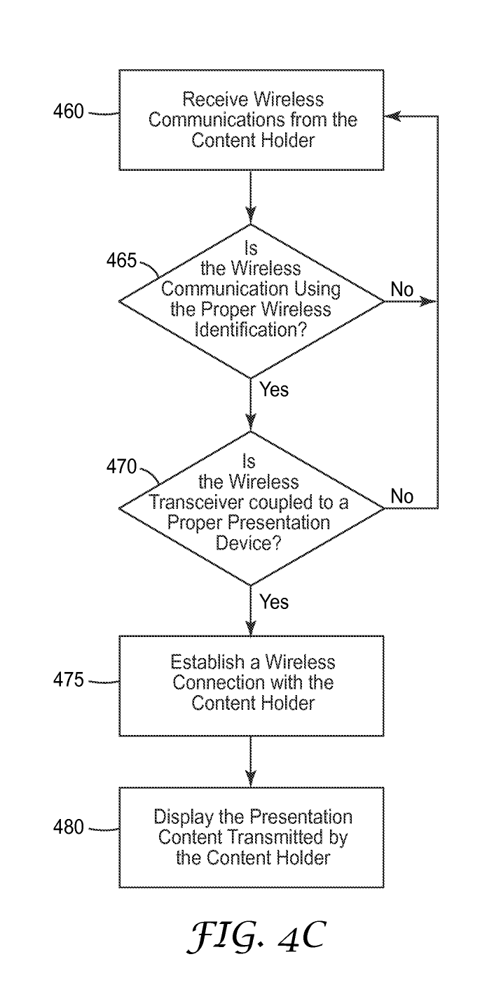

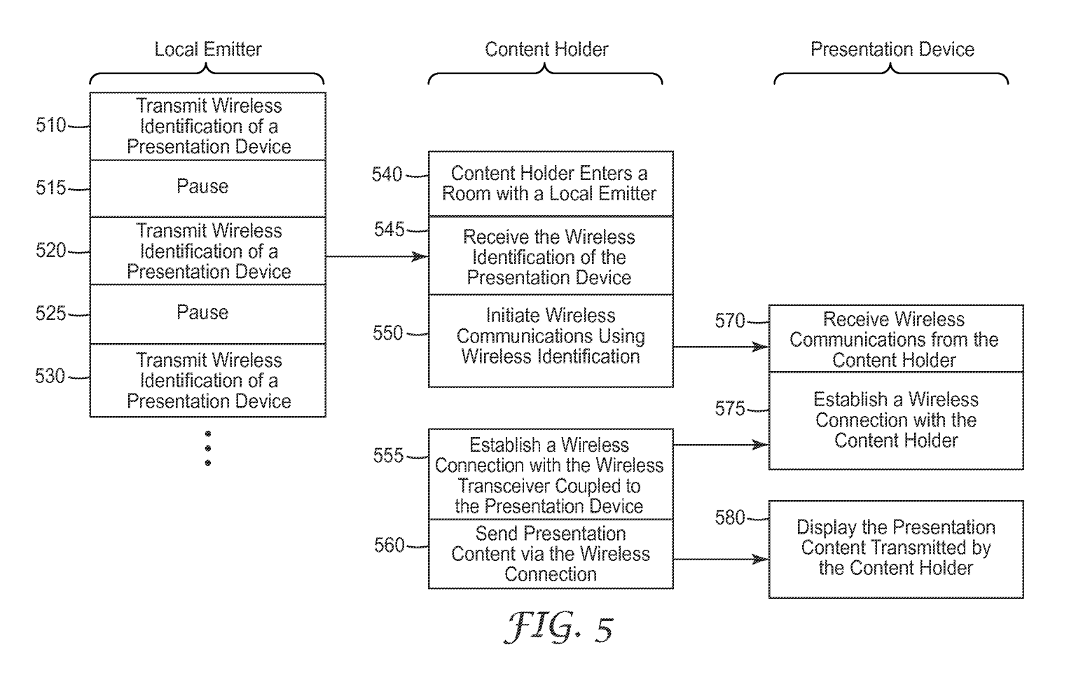

FIG. 4A is an exemplary logical flowchart of a line-of-sight communication transmitter. The line-of-sight communication transmitter sends the wireless identification (ID) of a presentation device repeatedly (step 410). The transmission pauses for a predetermined amount of time between the transmissions of the wireless ID (step 420). In some implementations, the predetermined amount of time may be varied. In some implementations, such periodical transmissions may be triggered by certain events, for example, sensor events, motion detection events, button switching events, or other events.

FIG. 4B is an exemplary logical flowchart of a content holder. First, the content holder, via a coupled line-of-sight communication receiver, receives the wireless identification of the presentation device (step 430). Second, the content holder initiates wireless communications using wireless identification of the presentation device (step 440), via a wireless transceiver coupled to the content holder. Next, the content holder establishes a wireless connection with the wireless transceiver coupled to the presentation device (step 450). Further, the content holder sends presentation content via the wireless connection (step 455). In some implementations, the content holder may send control data to presentation device via the wireless connection. The control data may include the configuration of the presentation device, and other control signals.

In some embodiments, the wireless connection can be disconnected if the line-of-sight receiver coupled to the content holder loses connection with the line-of-sight transmitter. This could be useful, for example, to automatically disconnect a content holder from a presentation device in the event that the device is removed from the room containing the presentation device.

One way to accomplish this is to have the line-of-sight receiver periodically seek a signal from the line-of-sight transmitter. If the signal isn't detected, the content holder can disconnect from the wireless connection. In some implementations, if the wireless identification of the presentation device is not continued to be detected on a periodic basis, then after some time intervals, the wireless connection with the wireless transceiver is abandoned. In some other implementations, the line-of-sight transmitter can periodically update an encryption key required to maintain communications with a wireless transceiver, thus the wireless communication is disconnected if a content holder is no longer receiving the current encryption key. The period for verifying that the content holder is still in the room can be chosen based on the expected use of the implementation. The period can be, for example, 1 hour or less, 30 minutes or less, 10 minutes or less, 5 minutes or less, 2 minutes or less, or 1 minute or less.

FIG. 4C is an exemplary logical flowchart of a presentation device along with a coupled wireless transceiver. A wireless transceiver may be coupled to a single presentation device or a plurality of presentation devices. If the wireless transceiver is coupled to more than one presentation device, the wireless identification of the presentation device may include device identification. Initially, a wireless transceiver coupled to the presentation device receives wireless communications from the content holder (step 460). Next, the wireless transceiver or the presentation device verifies whether the wireless communication is using the proper wireless identification (step 465). If the wireless identification is not proper, the wireless transceiver or the presentation device will discard the communications. If the wireless identification is proper, optionally, the wireless transceiver will check whether it is coupled to a proper presentation device (step 470). If a proper presentation device is coupled, the presentation device establishes a wireless connection with the content holder via the wireless transceiver (step 475). Next, the presentation device may display the presentation content transmitted by the content holder (step 480).

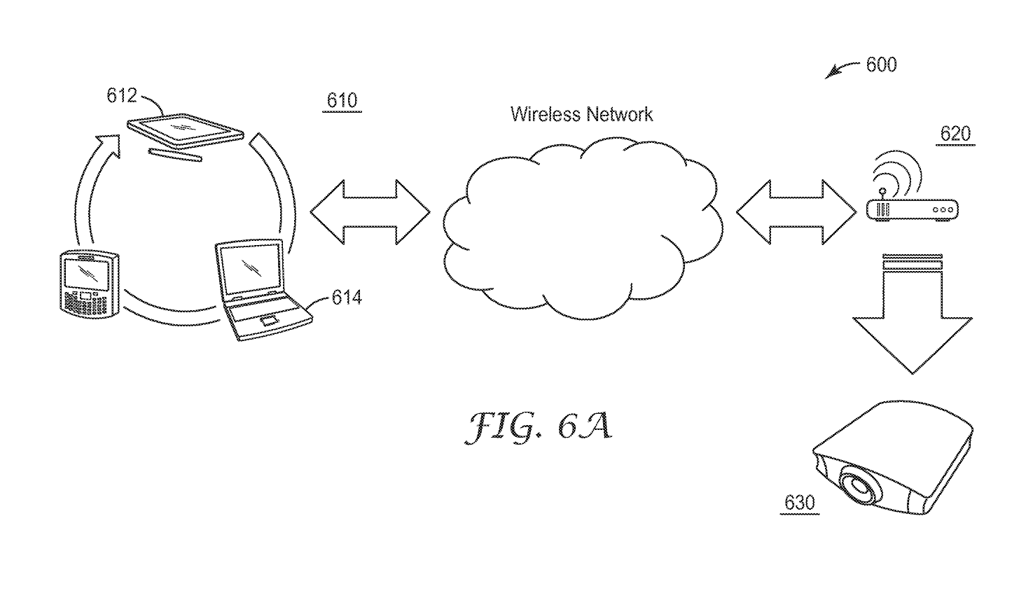

FIG. 5 is an exemplary sequential interaction flowchart of components in a wireless presentation system allowing automatic association and connection. The flowchart illustrates interactions between a local emitter, also referred to as a line-of-sight communication transmitter herein, a content holder, and a presentation device. The local emitter transmits the wireless identification (ID) of the presentation device repeatedly (steps 510, 520, 530). The local emitter pauses between data transmissions (steps 515, 525). The content holder enters a room where the local emitter is located (step 540). The content holder, via a coupled line-of-sight communication receiver, receives the wireless identification of the presentation device (step 545). Next, the content holder initiates wireless communications using wireless identification of the presentation device (step 550), via a wireless transceiver coupled to the content holder. Such wireless communications is received by a wireless transceiver coupled to the presentation device (step 570). A wireless connection between the content holder and the wireless transceiver coupled to the presentation device is established (steps 555, 575). Further, the content holder sends presentation content via the wireless connection (step 560). The presentation device may display the presentation content transmitted by the content holder (step 580).

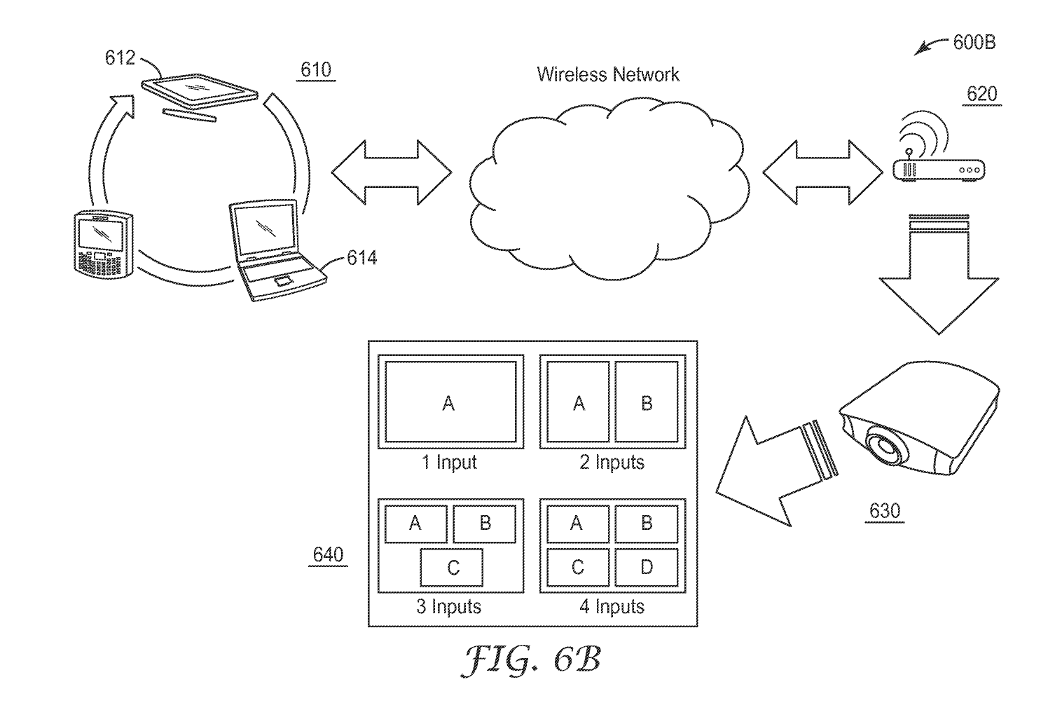

FIG. 6A illustrates an exemplary wireless presentation system 600 having a plurality of content holders 610, which include a moderator 614 and one or more client devices 612. In some embodiments, the wireless presentation system 600 includes a wireless transceiver 620 and a presentation device 630. The wireless transceiver 620 is coupled to the presentation device 630. With wireless content transfer, there is no physical way to grant or revoke access to one content holder or another one. The content holders 610 can be mobile phones, tablets, computers, or any other wireless-enabled device. Each content holder 610 may be in the role of a moderator or a client device. A moderator is a device that coordinates various devices in a wireless presentation system, which also has control and access to the presentation device in the wireless presentation system. A moderator may render content to be presented by the presentation device 630. In some cases, a client device is a device that a moderator controls its access to the presentation device 630. In some implementations the moderator may receive content directly from the client device and pass that content to the presentation device 630. In some other implementations, the client device may be configured to transmit the content directly to the presentation device 630. In such implementations, the moderator device controls what is being displayed by configuring the presentation device 630 to accept or reject content from each client device. The present disclosure is directed to systems and methods for determining how access is controlled when multiple content holders request access to a presentation device.

In one embodiment, the wireless presentation system 600 includes one moderator 614 and one or more client devices 612. The moderator has initial control over the display. If a client device desires control to the presentation device 630, a request is submitted to the moderator. The moderator may take one of three actions: 1) denying access; 2) allowing content streaming while the moderator retains navigation control (i.e., pause, play, stop, etc.); 3) allowing content streaming and passing navigation control to the client device. Optionally, the moderator can send a command to the client device to stop streaming and regain control to the presentation device 630. Such configuration could be useful in a classroom setting. For example, a teacher having a moderator device could allow students, having client devices, to share media from their own devices. Meanwhile, the teacher could control what to be displayed and regain control to the presentation device at any time.

In another embodiment, the wireless presentation system 600 initially includes a plurality of client devices. The first client devices acquiring connection automatically becomes a moderator controlling the presentation device 630. If a second client device desires control and access to the presentation device, a request is submitted to the moderator. The first client device may grant control to the presentation device 630 to the second client device. The second client device may become a new moderator and gain full access and control to the wireless presentation system. Alternatively, the first client device may deny the request from the second client device and remain as a moderator. In some implementations, if the first client device does not take action within a predetermined period of time, control is automatically passed to the second client device. Such configuration could be useful in a conference room. A primary presenter could retain control of the presentation device until someone else needs it. If the primary presenter leaves the room, remaining participants can gain control of the presentation device by requesting control, waiting for a timeout after the predetermined period of time, and gaining control to the presentation device. Control of the presentation device may also pass automatically to another participant, without the need for a request, if the primary presenter is automatically disconnected from the system as described above.

In yet another embodiment, the wireless presentation system 600 includes a plurality of client devices having different levels of control settings. For example, a client device may be granted an Administrative level of control that would allow the client device to control the wireless presentation system and become a moderator at any time. A client device may be granted a Standard User level of control that allows the client device to become a moderator if a request to be moderator is granted or a timeout occurs. A client device may also be granted a Guest level of control that may allow the client device provide content and be granted navigation control to the presentation device, but can never be a moderator. The possible levels of control settings may be changed in a particular room according to schedule and day-parts (i.e., morning, afternoon, evening, rush hours, etc.).

FIG. 6B illustrates a further exemplary embodiment of a wireless presentation system having a plurality of content holders. In one embodiment, the moderator of the wireless presentation system 600 may render content to a screen 640 from a single input, or more than one inputs to be displayed by the presentation device. In some implementations, the moderator can split the screen 640 to accommodate multiple client devices. In some cases, each client device may request access to a specific sub-screen, for example, sub-screen 2 as illustrated in FIG. 6B. The moderator may grant or deny such request. In other cases, each client device presents its content to an assigned sub-screen, for example, sub-screen 3 as illustrated in FIG. 6B. The moderator may split the screen 640 to a number of sub-screens based on the number of client devices or users at the beginning of a presentation section. In some implementations, the moderator may split the screen 640 dynamically throughout a presentation.

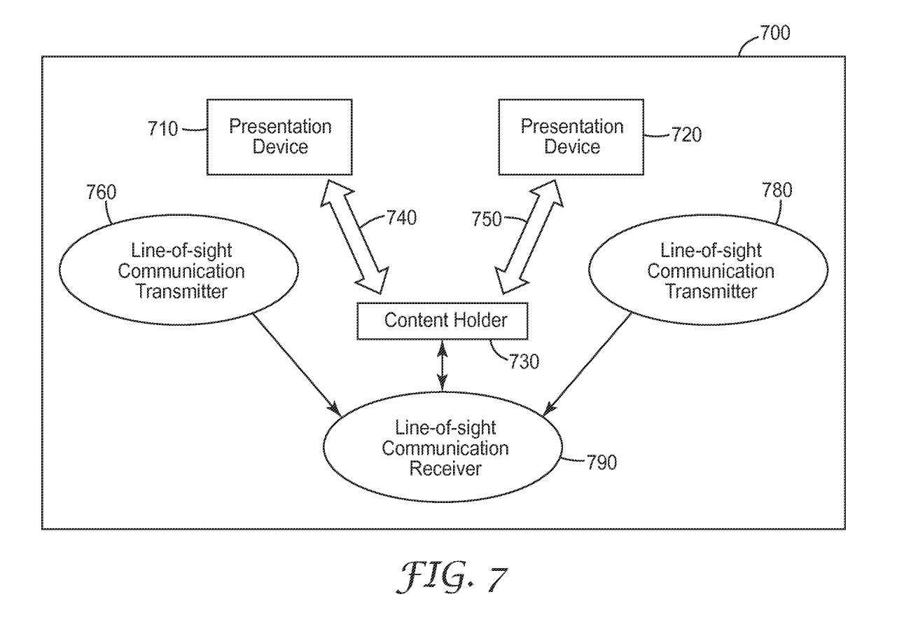

FIG. 7 illustrates an exemplary wireless presentation system 700 having two presentation devices. In one embodiment, the wireless presentation system 700 includes a first presentation device 710, a second presentation device 720, a content holder 730, a first line-of-sight communication transmitter 760, and a line-of-sight communication receiver 790 coupled to the content holder 730. Such a configuration could be desirable in large meeting areas. In some implementations, the first line-of-sight communication transmitter 760 may send the wireless identification of the first presentation device 710 and the wireless identification of the second presentation device 720 via a line-of-sight communication interface. In some other implementations, the wireless presentation system 700 includes a second line-of-sight communication transmitter 780. In such configuration, the first line-of-sight communication transmitter 760 may transmit the wireless identification of the first presentation device 710 and the second line-of-sight communication transmitter 780 may transmit the wireless identification of the second presentation device 720.

In one embodiment, the line-of-sight communication receiver 790 may receive the wireless identifications of the first and the second presentation devices and pass the data to the content holder 730. In some implementations, the content holder 730 may establish a first wireless connection 740 with the first presentation device 710 and a second wireless connection 750 with the second presentation device 720 using the received data via line-of-sight communication. The content holder 730 may send presentation content to the first presentation device 710 via the first wireless connection 740 and to the second presentation device via the second wireless connection 750. In some other implementations, the content holder 730 may establish a first wireless connection 740 to a wireless transceiver (not shown in FIG. 7) coupled to both the first presentation device 710 and the second presentation device 720. In such a configuration, the wireless identification of the first and the second presentation devices may include both an address directing to the wireless transceiver, a first device identification for the first presentation device, and a second device identification for the second presentation device. After the wireless connection 740 is established, the content holder 730 may transmit presentation content to the wireless transceiver and the presentation content may further routed to both the first presentation device 710 and the second presentation device 720. After the first presentation device 710 and the second presentation device 720 receive presentation content from the content holder 730, the presentation content can be displayed by both the first presentation device 710 and the second presentation device 720.

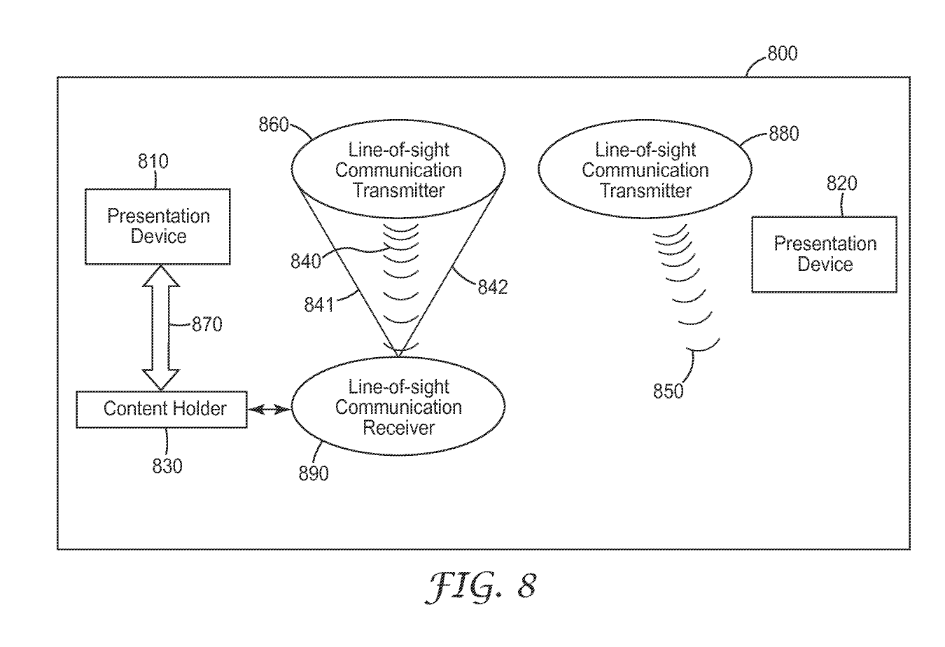

FIG. 8 illustrates another exemplary wireless presentation system 800 having two presentation devices. In one embodiment, the wireless presentation system 800 includes a first presentation device 810, a second presentation device 820, a content holder 830, a first line-of-sight communication transmitter 860 associated with the first presentation device 810, a second line-of-sight communication transmitter 880 associated with the second presentation device 820, and a line-of-sight communication receiver 890 coupled to the content holder 830. The first line-of-sight communication transmitter 860 is configured to transmit line-of-sight communication signals 840. The second line-of-sight communication transmitter 880 is configured to transmit line-of-sight communication signals 850. In some implementations, it is intended that the presentation content be displayed only on one specific presentation device, for example, the presentation device 810. In some configurations, the line-of-line communication receiver 890 may have an angularly limited field of view. As an example, the line-of-sight communication receiver 890 may have an angularly limited field of view defined by line 841 and line 842. As noted above, the line-of-sight communication receiver 890 may be an integrated part of the content holder 830 or a device separated from the content holder.

In some implementations, a user may point the line-of-sight communication receiver 890 toward the line-of-sight communication transmitter associated with the presentation device of interest. For example, a user may point the line-of-sight communication receiver 890 toward the first line-of-sight communication transmitter 860 such that the line-of-sight communication receiver 860 can receive data transmitted from the first line-of-sight communication transmitter 860 and a wireless connection 870 may be established between the content holder 830 and the first presentation device 810. In this example, the presentation content transmitted from the content holder 830 could only be displayed on the first presentation device 810 but not displayed on the second presentation device 820. In such an implementation, although the first presentation device 810 and the second presentation device 820 may be in a common room, the content holder can limit its presentation content to be displayed to only one presentation device of interest. This process requires some limited user involvement.

In an exemplary embodiment, the line-of-sight communication receiver 890 could be a near-field communications (NFC) receiver, and the first line-of-sight communication transmitter 860 and the second line-of-sight communication transmitter 880 are two NFC pads (i.e., NFC transmitters). A user could simply swipe the line-of-sight communication receiver 890 across the NFC pad associated with the presentation device of interest to associate the content holder 830 with the desired presentation device. In such an implementation, it requires only minimal user participation in establishing a data link between a content holder and a presentation device.

In another exemplary embodiment, the presentation device is a projection device that projects the image onto a projection screen. The line-of-sight communication transmitter projects a signal such as an IR signal onto the projection screen. This line-of-sight communication signal is reflected by the projection screen. A user may then point a line-of-sight communication receiver toward the screen of interest in order to initiate the process for establishing communication with the projection device associated with that projection screen.

The present invention should not be considered limited to the particular examples and embodiments described above, as such embodiments are described in detail to facilitate explanation of various aspects of the invention. Rather the present invention should be understood to cover all aspects of the invention, including various modifications, equivalent processes, and alternative devices falling within the spirit and scope of the invention as defined by the appended claims.

What is claimed is:

1. A system, comprising:
a first presentation device having a wireless identification;
a line-of-sight communication transmitter configured to transmit the wireless identification of the first presentation device via a line-of-sight communication transmission;
a line-of-sight communication receiver configured to receive the wireless identification of the first presentation device;
a first content holder communicatively coupled to the line-of-sight communication receiver and configured to obtain the wireless identification of the first presentation device from the line-of-sight communication receiver, the first content holder further configured to establish a first wireless connection with the first presentation device using the wireless identification of the first presentation device and transmit content to the first presentation device via the first wireless connection; and
a second content holder configured to provide content to the first presentation device,
wherein the first content holder is further configured to control whether the content provided by the second content holder will be presented on the first presentation device.

2. The system of claim 1, wherein the line-of-sight communication transmission is established by a light emission, a sonic emission, or a near field communication.

3. The system of claim 1, wherein the line-of-sight communication transmitter is further configured to transmit an encryption key via the line-of-sight transmission and further wherein data transmitted via the wireless connection is encrypted with the encryption key.

4. The system of claim 1, wherein the line-of-sight communication transmitter is further configured to transmit a pass code via the line-of-sight transmission, and wherein the line-of-sight communication receiver is further configured to receive the pass code, and further wherein the first content holder is further configured to use the pass code to establish the first wireless connection with the first presentation device.

5. The system of claim 1, wherein the line-of-sight communication transmitter is an integrated part of the first presentation device.

6. The system of claim 1, wherein the second content holder is configured to request the first content holder to grant control access to the first presentation device, and wherein the second content holder is granted control access to the first presentation device by the first content holder.

7. The system of claim 1, wherein the second content holder is configured to request the first content holder to grant control access to the first presentation device, and wherein the second content holder is granted control access to the first presentation device after a predetermined time period.

8. The system of claim 1, further comprising:
a second content holder configured to establish a second wireless connection with the first presentation device,
wherein the first presentation device is further configured to transmit content transmitted from the first content holder to the second content holder.

9. The system of claim 1, further comprising:
a second presentation device having a wireless identification, and
a second line-of-sight communication transmitter configured to transmit the wireless identification of the second presentation device via a line-of-sight communication transmission,
wherein the line-of-sight communication receiver is further configured to receive the wireless identification of the second presentation device,
wherein the first content holder is further configured to obtain the wireless identification of the second presentation device via the line-of-sight communication receiver and establish a second wireless connection with the second presentation device using the wireless identification of the second presentation device, and
wherein the first content holder is further configured to transmit content to the first presentation device via the first wireless connection and transmit content to the second presentation device via the second wireless connection.

10. The system of claim 1, further comprising:
a second presentation device having a wireless identification,
wherein the line-of-sight communication transmitter is further configured to transmit the wireless identification of the second presentation device via a line-of-sight communication transmission,
wherein the line-of-sight communication receiver is further configured to receive the wireless identification of the second presentation device,
wherein the first content holder is further configured to obtain the wireless identification of the second presentation device via the line-of-sight communication receiver and establish a second wireless connection with the second presentation device using the wireless identification of the second presentation device, and
wherein the first content holder is configured to transmit content to the first presentation device via the first wireless connection and transmit content to the second presentation device via the second wireless connection.

11. The system of claim 1, wherein the line-of-sight transmitter is further configured to transmit a periodic signal, and wherein the first content holder is further configured disconnect from the first wireless connection after the line-of-sight receiver does not receive the periodic signal.

12. A method, comprising:
transmitting, by a line-of-sight communication transmitter, a wireless identification of a presentation device via a line-of-sight transmission;
receiving, by a line-of-sight communication receiver coupled to a content holder, the wireless identification of the presentation device;
establishing a wireless connection between the presentation device and the content holder using the wireless identification of the presentation device;
sending presentation content via the wireless connection, via the content holder, to the presentation device;
transmitting, by the line-of-sight communication transmitter, a periodic signal;
receiving, by the line-of-sight communication receiver, the periodic signal; and
disconnecting the content holder from the wireless connection after the periodic signal is not received.

13. The method of claim 12, wherein the line-of-sight communication transmission is established by a light emission, a sonic emission, or a near field communication.

14. The method of claim 12, further comprising:
transmitting, by the line-of-sight communication transmitter, an encryption key via the line-of-sight transmission;
receiving, by the line-of-sight communication receiver coupled to the content holder, the encryption key;
encrypting content with the encryption key by the content holder; and
transmitting the encrypted content via the wireless connection.

15. The method of claim 12, further comprising:
transmitting, by the line-of-sight communication transmitter, a pass code via the line-of-sight transmission;
receiving, by the line-of-sight communication receiver coupled to the content holder, the pass code; and
establishing, by the content holder, the wireless connection with the presentation device using the pass code.

16. A system, comprising:
a first presentation device having a wireless identification;
a line-of-sight communication transmitter configured to transmit the wireless identification of the first presentation device via a line-of-sight communication transmission established by a light emission, a sonic emission, or a combination thereof;
a line-of-sight communication receiver configured to receive the wireless identification of the first presentation device; and
a first content holder communicatively coupled to the line-of-sight communication receiver and configured to obtain the wireless identification of the first presentation device from the line-of-sight communication receiver, the first content holder further configured to establish a first wireless connection with the first presentation device using the wireless identification of the first presentation device and transmit content to the first presentation device via the first wireless connection.
